(19) United States
(12) Patent Application Publication
(10) Pub. No.: US 2026/0310402 A1
(43) Pub. Date: Oct. 8, 2026

(54) Voice Controlled Vision Blocker Shield Attachment for a Headset

(71) Applicant: DANIEL M. BANKS, Bristol, TN (US)

(72) Inventor: DANIEL M. BANKS, Bristol, TN (US)

(21) Appl. No.: 19/172,926

(22) Filed: Apr. 8, 2025

(51) Int. Cl. G06F 3/16; G02B 27/01

(52) U.S. Cl. CPC G06F 3/167; G02B 27/0176

(57) ABSTRACT

A device fans out two semi circles into a circular shield to block the mouth from other people's vision when a person starts to speak automatically. When the person stops speaking the shields retract into their enclosure. It is designed to clip onto a headset. A best-use example would be a coach calling a play; it would block people from reading the lips to steal the play.

### 4. BACKGROUND TO INVENTION

5. When watching a football game, I noticed that every coach must use his play book to cover his lips when talking. If he does not, people can potentially read his lips when the cameras are on him. This has led to the opposing team knowing what call is played and reacting to the stolen play.

### 1. SUMMARY OF THE INVENTION

2. The Voice Controlled Vision Blocker Shield would free the coach from worry. The Blocker shield will be attached to the coach's headset resting in front of his mouth. When he speaks, the voice is detected by a microphone or similar apparatus. There is an enclosure that houses two semicircular “fan” shapes consisting of several separate pieces. The detection of the voice expands each semicircle out of the enclosure, one on each side, completing a circular shield in front of the coach's mouth. When he stops speaking, the fans retract back into the enclosure. The blocker shield will have an on/off switch and be powered by batteries.

### 3. BRIEF DESCRIPTION OF THE DRAWINGS

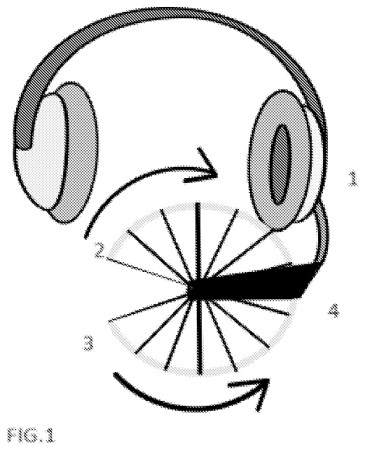

4. FIG. 1 shows the exterior view of the invention including

5. A Bluetooth or similar headset, to which the enclosure is attached

6. The top fan which expands and retracts from the enclosure

7. The bottom fan which expands and retracts from the enclosure

8. An enclosure that holds the fans, electronics, batteries etc. It attaches to the headset.

### 9. DETAILED DESCRIPTION OF THE INVENTION

### 10.1. Overview

11. The present invention relates to a voice-controlled vision-blocking shield attachment for a headset. This device is designed to provide privacy for individuals who need to prevent lip-reading when speaking, particularly in high-stakes environments such as sports coaching, business meetings, and confidential discussions. The invention features an automatic retractable shield that deploys when the user speaks and retracts when speech ceases, ensuring hands-free operation and seamless integration with existing headset designs.

### 12.2. Structure of the Device

13. The vision-blocking shield attachment comprises several key components:

### 14.a) Housing

15. The housing serves as the main enclosure for the device's components and is designed to attach securely to a headset.

16. It is made of lightweight, durable materials such as high-impact plastic or aluminum to ensure comfort and long-term usability.

17. The housing contains the power source, control circuitry, and actuator mechanism.

### 18.b) Microphone

19. A built-in microphone detects the user's voice, triggering the deployment of the shield.

20. The microphone is positioned to accurately capture speech while filtering out background noise to prevent accidental activation.

### 21.c) Retractable Shield Assembly

22. The shield consists of two semicircular fan-like components that are housed within the enclosure when not in use.

23. Upon voice detection, the fans extend outward from both sides of the enclosure to form a full circular shield in front of the user's mouth.

24. The shield material may be opaque, semi-transparent, or tinted, depending on user preference and application.

### 25. d) Actuator Mechanism

26. The actuator mechanism consists of a small motor or servo system that controls the expansion and retraction of the fans.

27. When speech is detected, the motor-driven system extends the shield smoothly and quickly.

28. Once the user stops speaking, the system automatically retracts the fans into the enclosure.

### 29.e) Power Source

30. The device is powered by a battery housed within the enclosure.

### 31.f) Control Switch

32. A manual on/off switch allows the user to enable or disable the vision-blocking shield as needed.

33. An additional override button may be included to manually deploy or retract the shield regardless of voice detection.

### 34.3. Operation and Functionality

35. Attachment to Headset: The device is designed to clip onto a standard Bluetooth or wired headset.

36. Automatic Activation: When the user begins speaking, the microphone detects the voice and sends a signal to the actuator mechanism.

37. Shield Deployment: The actuator extends the two semicircular fans outward to form a complete circular shield in front of the user's mouth.

38. Speech Cessation Detection: Once the user stops speaking, the microphone signals the actuator to retract the shield back into the enclosure.

39. Manual Override: The control switch allows the user to manually enable or disable the shield as needed.

### 40.4. Use Cases

41. Sports Coaching: Prevents lip-reading of play calls by opposing teams or media cameras.

42. Business & Finance: Ensures confidentiality in meetings and negotiations.

43. Personal Privacy: Protects individuals from unwanted eavesdropping in public spaces.

44. Medical & Military Applications: enhances security for confidential communications in sensitive environments.

### 45.5. Advantages

46. Hands-Free Operation: Automatic deployment and retraction ensure ease of use.

47. Lightweight and Portable: Designed for comfort and prolonged wearability.

48. Secure Fit: Attaches to standard headsets without interfering with audio functions.

49. This detailed description provides a comprehensive overview of the invention's design, structure, and functionality, ensuring clarity for potential manufacturers and patent examiners reviewing the specification.

1: A voice-activated vision-blocking shield attachment for a headset, comprising:
50.a) a housing configured to attach to a headset, the housing containing electronic components and a power source;
51.b) a microphone positioned to detect when a user is speaking;
52.c) a retractable shield assembly housed within the enclosure, the shield assembly comprising:
i) a first semicircular fan positioned on one side of the housing, and
ii) a second semicircular fan positioned on the opposite side of the housing, wherein the first and second semicircular fans are extendable to form a complete circular shield in front of the user's mouth;
53.d) an actuator mechanism configured to extend the first and second semicircular fans outward from the housing upon detecting speech via the microphone, and retract the fans back into the housing when speech ceases; and
54.e) a control switch operable by the user to enable or disable the shield's functionality.
55.
56.
